(19) United States
(12) Patent Application Publication
(10) Pub. No.: US 2024/0174344 A1
(43) Pub. Date: May 30, 2024

(54) FLOW BODY FOR AN AIRCRAFT WITH SPLIT RIBS

(71) Applicant: Airbus Operations GmbH, HAMBURG (DE)

(72) Inventors: Stefan BENSMANN, HAMBURG (DE); Martin FEES, HAMBURG (DE)

(21) Appl. No.: 18/501,226

(22) Filed: Nov. 3, 2023

(30) Foreign Application Priority Data
Nov. 30, 2022 (EP) 22210462.2

(51) Int. Cl. B64C 3/26; B64C 3/18

(52) U.S. Cl. CPC B64C 3/26; B64C 3/187; B64C 3/28

(57) ABSTRACT

A flow body for an aircraft includes a front skin having an outer surface configured to be contacted by an ambient flow, and an inner surface opposite the outer surface, at least one rib arranged inside the flow body and having a first side and a second side. The at least one rib comprises two independent flanges. The two flanges extend from a common junction section, which is arranged between the first side and the second side, to the first side. The two flanges diverge towards the first side. Each flange comprises an attachment strap at the first side for attaching the respective flange to the front skin. The respective attachment strap has a shape corresponding to the shape of the inner surface of the front skin.

### CROSS-REFERENCES TO RELATED APPLICATIONS

This application claims the benefit of the European patent application No. 22210462.2 filed on Nov. 30, 2022, the entire disclosures of which are incorporated herein by way of reference.

### FIELD OF THE INVENTION

The invention relates to a movable flow body for an aircraft, a wing for an aircraft as well as an aircraft.

### BACKGROUND OF THE INVENTION

For increasing the lift coefficient of a wing of an aircraft, high-lift systems are known. These often include trailing edge flaps and movable leading-edge devices, which are selectively operable. For example, they are usually activated during takeoff and landing, i.e., moved from a retracted into an extended position.

Leading-edge devices may include leading-edge slats, which are flow bodies usually having a front skin, a back skin, and mechanical interfaces for coupling with a slat track or another drive mechanism. One or several ribs are often provided inside the flow bodies for stiffening and for carrying the skins. For example, ribs are often made from a metallic material and extend straightly to the front skin, and often run parallel to the longitudinal axis of the aircraft or perpendicular to the leading edge of the respective flow body. This results in a high stiffness step in a contact region with the front skin. In case of a bird strike, the front skin may thus experience a rupture in this region.

Exemplarily, U.S. Pat. No. 8,276,847 B2 proposes a cover for an aircraft structure, in particular for nose parts of the vertical tail, horizontal tail or the wing, including a skin and a support structure. The skin is arranged on the support structure and the support structure includes a plurality of ribs and a plurality of stringers. The plurality of stringers are arranged on the plurality of ribs to support the skin and each comprise a multitude of weakened areas positioned opposite to a stringer base, which stringer base is adapted to support the skin, in order to increase a plastic deformation area.

### SUMMARY OF THE INVENTION

It is an object of the invention to propose an alternate flow body, which can withstand bird strikes and which is able to eliminate or strictly limit ruptures in its skin.

A flow body for an aircraft is proposed, comprising a front skin having an outer surface configured to be contacted by an ambient flow, and an inner surface opposite the outer surface, at least one rib arranged inside the flow body and having a first side and a second side, wherein the at least one rib comprises two independent flanges, wherein the two flanges extend from a common junction section, which is arranged between the first side and the second side, to the first side, wherein the two flanges diverge towards the first side, and wherein each flange comprises an attachment strap at the first side for attaching the respective flange to the front skin, wherein the respective attachment strap has a shape corresponding to the shape of the inner surface of the front skin.

The flow body and, in particular, the front skin, may form a nose part of a vertical tailplane, a horizontal tailplane, an engine nacelle or of a wing of an aircraft. It may be a fixed or a movable flow body. For example, the flow body may comprise an elongate shape that extends along a spanwise direction, if it forms part of the wing or of the horizontal tailplane. The flow body further comprises a certain profile contour, which is mainly determined by the desired aerodynamic characteristics. It is preferred that the flow body is sufficiently stiff to serve for the intended purpose. It is conceivable that the flow body comprises a plurality of stiffening elements, such as ribs, spars, and stringers, which are distributed inside the flow body. The at least one rib may extend parallel to the longitudinal direction of the aircraft or substantially perpendicular to a leading edge of the flow body. In the following, the term “first side” refers to a leading edge side of the flow body, wherein the “second side” refers to the opposite side.

Thus, the flow body according to the invention is basically comparable to a common flow body and has a curved front skin in contact with an ambient air flow. In an interior of the flow body, one of the stiffening elements includes at least one rib, which is designed according to the above. Hence, the respective rib does not comprise a single web that straightly extends from the first side to the second side. Instead, the web is split into two flanges, which run from a common junction section at a location between the first side and the second side towards the inner surface of the front skin. The flanges diverge from each other between the junction section and the inner surface of the front skin in a way that their distance increases towards the front skin. It is conceivable that the at least one rib refers to two or more ribs, if a flow body with a larger spanwise extension is considered.

By changing the web design from a single web to two obliquely arranged flanges, the rib has a decreased stiffness in the resulting two contact regions compared to the single contact region of a single web. A bird strike or another impact of an object onto the flow body thus leads to a greater deformation of the front skin, which may be accompanied by a bending deformation of the flanges due their reduced stiffness and oblique orientation. The front skin is thus able to absorb more kinetic energy before it experiences a rupture, which clearly reduces the risk of a damage of the respective flow body.

The common junction section is to be understood as a section of the at least one rib, where the two flanges merge into a web of the at least one rib. At the first side, i.e., at the forward ends of the flanges, the attachment straps of the two flanges are provided. Due to the diversion of the flanges, the attachment straps are placed at a distance to each other. The front skin may thus deform into an intermediate space between two adjacent attachment straps, thereby further bending the diverting flanges away from each other.

The attachment straps extend away from the flanges and conform the shape of the inner surface of the front skin. They allow to provide a connection of the front skin to the at least one rib through fasteners, such as rivets, or through material bonding.

The at least one rib may be a simple stiffening rib or it may be a load introduction rib, which is coupled with a drive mechanism for driving the flow body. A load introduction rib would be mechanically adapted to provide a reliable load transfer between the flow body and the drive mechanism, such as a slat track mechanism or similar. The rib would then comprise a coupling element at the second side.

The rib may be made from a metallic material, e.g., by bending a sheet metal material, by milling a metal workpiece or by an additive manufacturing process. As an alternative, a plastic material, in particular a fiber reinforced plastic material, such as CFRP, may be used. Depending on the desired shape and dimension, it is also conceivable that the at least one rib is made from two halves, which are joined together in a web section and the junction section, wherein the two flanges are each created by one the halves. Joining the halves may be conducted through fasteners, such as rivets, or through materially bonding, e.g., welding, gluing or co-curing. It is conceivable to use fasteners for joining the halves, when they are made from a metal material or from a fiber reinforced plastic material. If a metal material or a thermoplastic material are used, a welding connection may also be provided. If a thermoset plastic material is used, also co-curing of both halves may be conducted.

In an advantageous embodiment, the attachment straps each comprise a bonding surface facing the inner surface of the front skin, wherein the straps are materially bonded to the inner surface of the front skin. Materially bonding the bonding surface and the inner surface may be conducted by one of several possible processes that allow to provide a sufficiently sturdy connection of the flanges and the front skin. For example, the attachment straps and the inner surface may be bonded by gluing, welding, or co-curing. In all cases, a riveting connection between the attachment straps and the front skin can be eliminated, which leads to a clean outer surface of the front skin and an elimination of induced drag stemming from rivets.

In an advantageous embodiment, the attachment straps each comprise a bonding surface facing the inner surface of the front skin, wherein the attachment straps are materially bonded to the inner surface of the front skin. Depending on the material used for the front skin and the at least one rib, several different bonding processes may be used. For example, both components may be glued, or welded together. If a thermoset material is used, the components may be co-cured to form a connection therebetween.

However, common other fastening techniques may be used, for example riveting.

In an advantageous embodiment, the flanges are substantially planar between the junction section and the attachment straps. Thus, the distance between both flanges increases proportionally with increasing distance to the junction section. This simplifies the manufacturing and may eliminate complex manufacturing tools.

In an advantageous embodiment, the flanges between the junction section and the attachment straps are curved, such that a distance increase between the two flanges along the course from the junction section towards the first side is progressive. This substantially prevents that an impact direction of an object can be coplanar with one of the flanges. Thus, substantially under all impact directions of an object, a bending or buckling load acts onto the flanges, which lead to increasing the amount of kinetic energy that is absorbed by the flow body.

In an advantageous embodiment, the at least one rib further comprises a substantially flat web section between the junction section and the second end. The web section may comprise two or more different thicknesses, but substantially extends along a single plane from the junction section to the second end. The part between the junction section and the second end may thus correspond to a common design of a rib.

In an advantageous embodiment, the at least one rib further comprises a collar extending transversely away from the rib, wherein the collar is arranged on or adjacent to the junction section. The collar allows a connection with a spar or another structural element inside the flow body. The collar may thus act similar to a flange for a load transfer. If a flow body without a spar or other respective structural element is provided, the collar may be eliminated. Still further, the collar may increase the structural stability of the at least one rib directly at the junction section. Thus, a deformation of the at least one rib during an impact mainly develops at the part between the junction section and the first end.

In an advantageous embodiment, the two flanges enclose a transition region adjacent to the junction section and facing the front skin, wherein the transition region is rounded and substantially free of kinks. A rupture of the rib starting from a more or less pronounced edge in the transition region and traveling to the second end may thus be prevented.

In an advantageous embodiment, a common web section is arranged between the junction section and the collar. This increases the stiffness of the at least one web even further and may allow to provide a larger transition to two flanges.

In an advantageous embodiment, at least one rib comprises a load introduction rib having at least one coupling element at the second side. Thus, not only stiffening ribs can be provided with the same design principle. A load introduction rib is to be understood a stiffening rib that is mechanically adapted for providing a reliable load transfer between the flow body and a drive mechanism, such as a slat track mechanism or similar. The coupling element is provided at the second side of the respective rib and may include at least one of a variety of different mechanical elements that allow to couple the respective rib with the drive mechanism.

In an advantageous embodiment, the at least one rib is made from two sheet material components that are joined together in a connection region between the junction section and the second side. The sheet material may be a metal material and/or a fiber reinforced plastic material. If metal sheets are used, they may be bent into shape and may be connected in the connection region through fasteners, such as rivets, bolts, and nuts. Alternatively, the metal sheets may be materially bonded, such as through welding or gluing. For example, the at least one rib is made from an aluminum alloy, while titanium may also be conceivable. However, if sheets of a fiber reinforced plastic material are used, the connecting process may depend on the properties of the material. For example, the fiber reinforced plastic material comprises a thermoplastic matrix, such as polyetherketoneketone (PEKK), polyetheretherketone (PEEK), polyetherimide, polycarbonate, poly-propylene and others. This would allow welding the two sheet material components together. However, the material may comprise a thermoset matrix, such that it may be feasible to co-cure both sheet material components to form an integral part. It is to be understood, that gluing the components together is also conceivable.

The invention further relates to a wing for an aircraft, comprising at least one flow body according to any of the preceding claims arranged in a leading-edge region.

In an advantageous embodiment, the at least one flow body is movably arranged on a fixed wing body of the wing. For example, the flow body may be a leading-edge slat or the like.

The invention also relates to an aircraft having at least one wing according to the above and/or at least one flow body according to the above. In general it is also possible to arrange the flow body according to the invention at a leading-edge region of a vertical tailplane, a horizontal tailplane, an engine nacelle or other.

### BRIEF DESCRIPTION OF THE DRAWINGS

In the following, the attached drawings are used to illustrate exemplary embodiments in more detail. The illustrations are schematic and not to scale. Identical reference numerals refer to identical or similar elements. They show:

FIGS. 1 and 2 show an exemplary embodiment of a flow body.

FIGS. 3 and 4 show a further exemplary embodiment of a flow body.

FIGS. 5 and 6 show a further exemplary embodiment of a flow body.

FIGS. 7 and 8 show a further exemplary embodiment of a flow body.

FIG. 9 shows an aircraft.

### DETAILED DESCRIPTION OF THE PREFERRED EMBODIMENTS

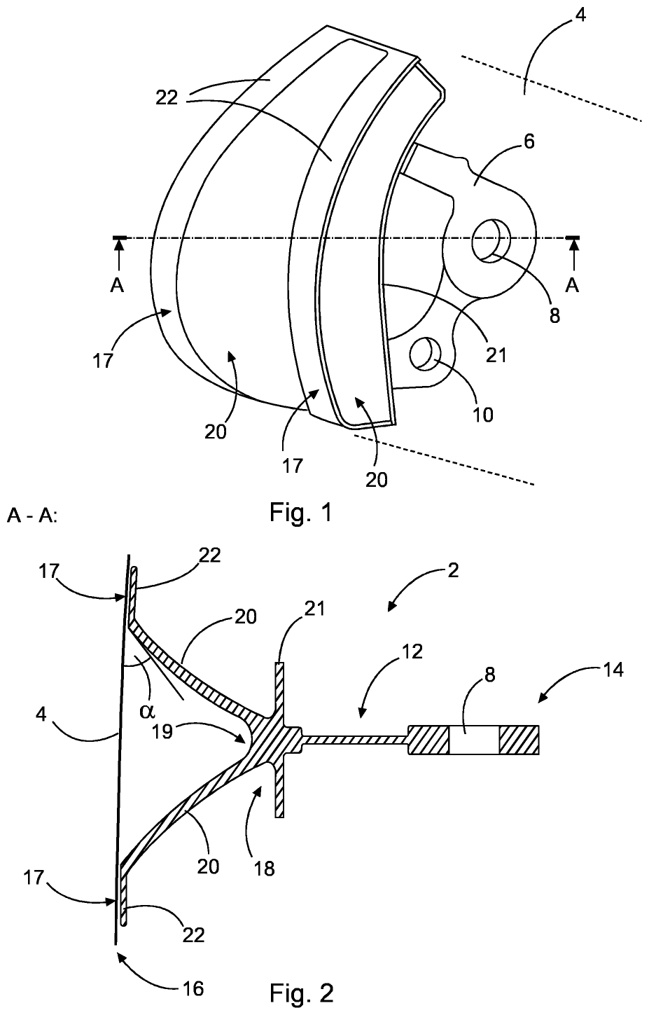

FIG. 1 shows a flow body 2 having a front skin 4 and at least one stiffening rib 6. Here, the stiffening rib 6 is shown as a load introduction rib, which has two lugs 8 and 10 for coupling with a drive mechanism, which is not shown herein. The front skin 4 is not shown in detail, but is indicated with dashed lines for improving the visibility of the interior structure of the flow body 2. In addition, FIG. 2 shows a cross-sectional view of the flow body 2, wherein the respective sectional plane is indicated by the letters A in FIG. 1.

The rib 6 comprises a web section 12, which includes the lugs 8 and 10. The lug 8 is arranged at a second side 14, while the front skin 4 is placed at the oppositely arranged first side 16. Between the first side 16 and the second side 14, a junction section 18 is provided, wherein the web section 12 extends from the junction section 18 to the second side 14. Two flanges 20 extend from the junction section 18 to the front skin 4. They enclose a transition region 19 adjacent to the junction section. The transition region 19 is completely rounded, such that a harmonic transition between the flanges 20 is made.

On their course to the front skin 4 the flanges 20 diverge, leading to a greater distance at the first side 16 than at the junction section 18. At the first side 16, attachment straps 22 are placed, which are in flush contact with an inner surface 24 of the front skin 4. They comprise a bonding surface 17 that is to be bonded or clamped to the inner surface 24. An outer surface 26, which is opposite to the inner surface 24, is in contact with the ambient flow of the flow body 2.

As demonstrated in FIG. 2, the flanges 20 are slightly curved in an outward direction and thus do not straightly extend to the front skin 4. In this exemplary embodiment, the curvature is substantially constant. At the first side 16, the flanges 20 and the front skin 4 enclose and angle α of about 40°. However, other angles are conceivable. If a bird or another object impinges onto the outer surface 26, the front skin 4 will deform.

Depending on the impact location, impact direction and impact strength, the flanges 20 will face a certain mechanical load that leads to a deformation of the flanges 20 as well. Due to their oblique arrangement and decreased stiffness compared to a single and transversely arranged flange, a larger area of the front skin 4 will be deformed, which in turn leads to a greater absorption of kinetic energy without creating a rupture in the front skin 4. Since the flanges 20 are not straight, an impact direction does not exist that solely acts in the plane of a flange 20 and the flanges 20 will substantially always face a bending or buckling force. Thus, the rib 6 comprises an improved impact behavior.

At the junction section 18, a collar 21 is provided, which substantially extends perpendicular to the web section 12 away from the junction section 18. This increases the axial area moment of inertia with respect to a local normal on the inner surface 24 of the front skin 4 and thus improves the mechanical stability of the rib 6. The web section 12 substantially extends between the collar 21 and the second side, wherein the flanges 20 substantially extend between the collar 21 and the first side 16.

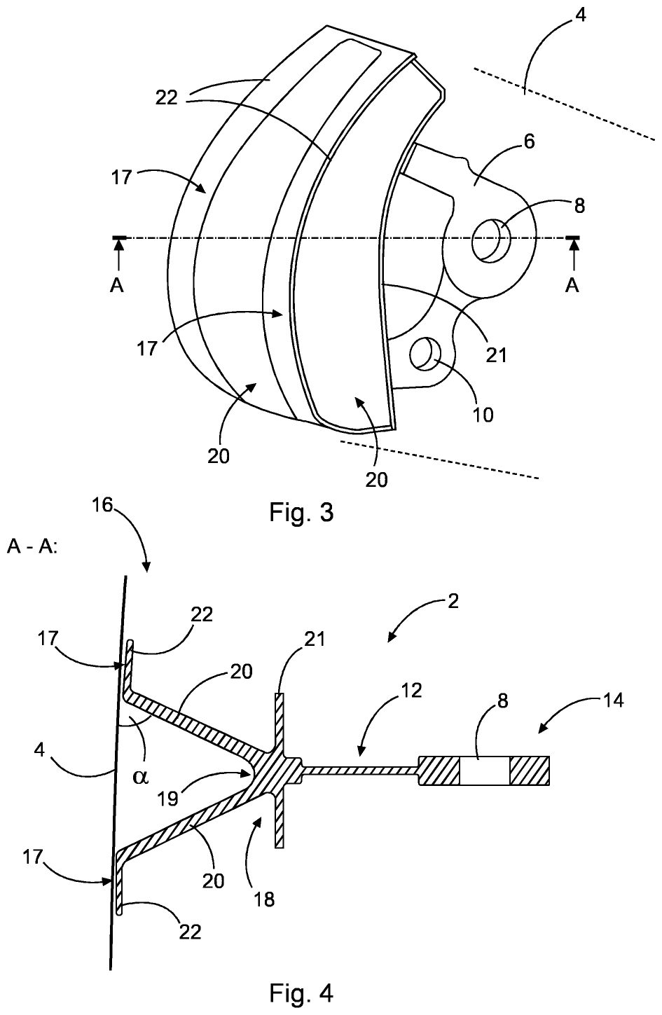

In FIGS. 3 and 4, the rib 6 is shown having two flanges 20 that extend along a straight line in the cross-sectional profile. This reduces the effort for manufacturing the rib 28 and will also lead to a bending and buckling force at least in the majority of impact directions.

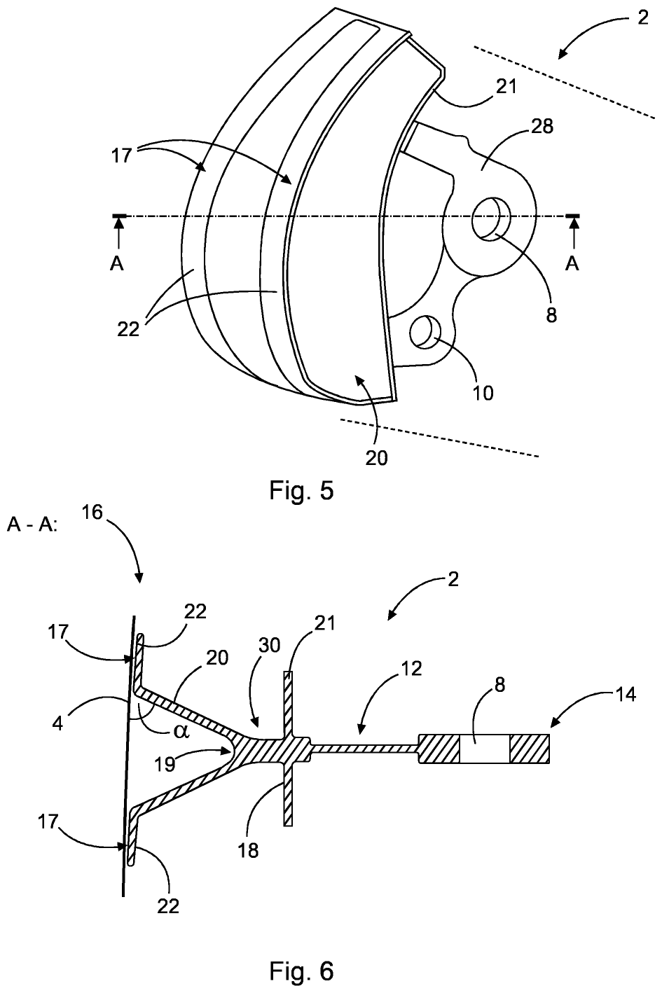

FIGS. 5 and 6 show a further exemplary embodiment in form of a rib 28, which is also created in the form of a load introduction rib. The general design is similar to the design shown in FIGS. 1 to 4. However, in addition to two straightly extending flanges 20, the rib 28 comprises a common web section 30, which may be understood as an extended common junction section. The common web section 30 extends between the collar 21 and the flanges 20 and leads to a greater stiffness of the rib 28 in this region.

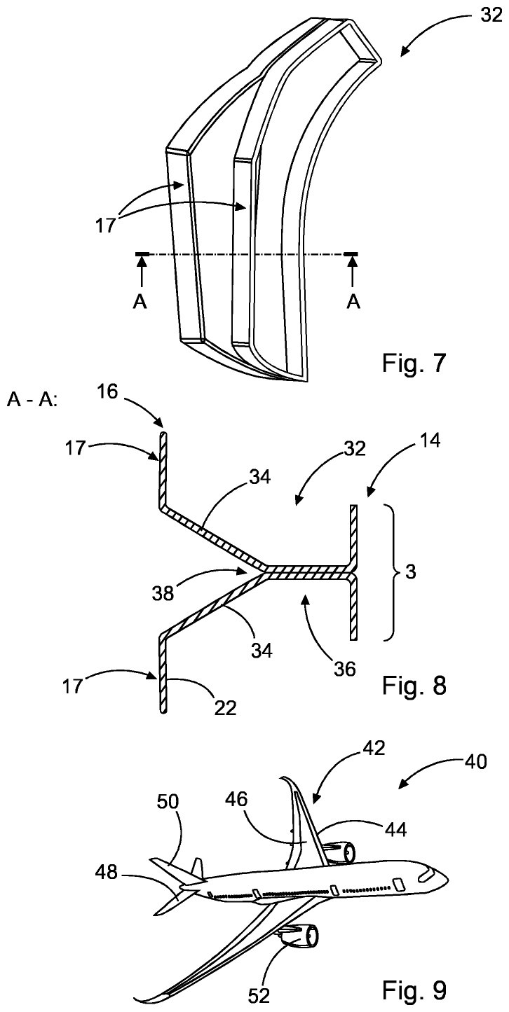

FIGS. 7 and 8 show a rib 32, which is designed as a stiffening rib and does not provide a load introduction feature. Here, the rib 32 is made from a sheet metal and comprises two halves 34, which are joined together to form a web section 36. The web section 36 also acts as a connection region, where both halves are connected. The connection may be provided through using fasteners, such as rivets or bolts. However, they may also be materially bonded. The halves 34 diverge from each other coming from the web section 36 running towards the first side 16. At the end of the web section 36 facing the front skin 4, a junction section 38 is created, where the two halves 34 are kinked and start to diverge.

At the second side 14 of the rib 32, an attachment flange 33 is provided, which is to be connected to a spar or another structural component inside the flow body or a back skin of the flow body 2 (not shown).

FIG. 9 shows an aircraft 40, having wings 42 with leading edges 44 and a fixed wing body 46, at which a flow body 2 according to the above may be provided. The aircraft 40 further comprises a horizontal tailplane 48, a vertical tailplane 50 and engine nacelles 52, which may also be equipped with a flow body 2 according to the above.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE NUMERALS

2 flow body
4 front skin
6 rib
8 lug
10 lug
12 web section
14 second side
16 first side
18 junction section
19 transition region
20 flange
21 collar
22 attachment strap
24 inner surface
26 outer surface
28 rib
30 common web section
32 rib
33 attachment flange
34 half
36 web section/connection region
38 junction section
40 aircraft
42 wing
44 leading edge
46 fixed wing body
48 horizontal tailplane
50 vertical tailplane
52 engine nacelle

1. A flow body for an aircraft, comprising:
a front skin having an outer surface configured to be contacted by an ambient flow, and an inner surface opposite the outer surface,
at least one rib arranged inside the flow body and having a first side and a second side,
wherein the at least one rib comprises two independent flanges,
wherein the two independent flanges extend from a common junction section, which is arranged between the first side and the second side, to the first side,
wherein the two independent flanges diverge towards the first side, and
wherein each of the two independent flanges comprises an attachment strap at the first side for attaching the respective flange to the front skin, wherein the respective attachment strap has a shape corresponding to the shape of the inner surface of the front skin.

2. The flow body according to claim 1,
wherein the attachment straps each comprise a bonding surface facing the inner surface of the front skin, and
wherein the bonding surfaces of the attachment straps are materially bonded to the inner surface of the front skin.

3. The flow body of claim 1, wherein the flanges are substantially planar between the junction section and the attachment straps.

4. The flow body according to claim 1, wherein the flanges between the junction section and the attachment straps are curved, such that a distance increase between the two flanges along a course from the junction section towards the first side is progressive.

5. The flow body according to claim 1, wherein the at least one rib further comprises a substantially flat web section between the junction section and a second end.

6. The flow body according to claim 1,
wherein the at least one rib further comprises a collar extending transversely away from the rib, and
wherein the collar is arranged on or adjacent to the junction section.

7. The flow body according to claim 1,
wherein the two flanges enclose a transition region adjacent to the junction section and facing the front skin, and
wherein the transition region is rounded and substantially free of kinks.

8. The flow body according to claim 6, wherein a common web section is arranged between the junction section and the collar.

9. The flow body according to claim 1, wherein at least one rib comprises a load introduction rib having at least one coupling element at the second side.

10. The flow body according to claim 1, wherein the at least one rib is made from two sheet material components that are joined together in a connection region between the junction section and the second side.

11. A wing for an aircraft, comprising at least one flow body according to according to claim 1 arranged in a leading-edge region of the wing.

12. The wing according to claim 11, wherein the at least one flow body is movably arranged on a fixed wing body of the wing.

13. An aircraft having at least one wing according to claim 11.

14. An aircraft having at least one flow body according to claim 1.
